(19) United States
(12) Patent Application Publication
(10) Pub. No.: US 2026/0310983 A1
(43) Pub. Date: Oct. 8, 2026

(54) Computer Platform for Human-in-the-Loop Reinforcement Learning

(71) Applicant: Google LLC, Mountain View, CA (US)

(72) Inventors: Amit Mohan Joshi, Menlo Park, CA (US); Yilun Liu, Mountain View, CA (US); Phillip Edward Dieter Maier, Cambridge, MA (US)

(21) Appl. No.: 19/483,166

(22) PCT Filed: May 1, 2024
(86) PCT No.: PCT/US2024/027222

§ 371 Date: Nov. 10, 2025

Related U.S. Application Data
(60) Provisional application No. 63/501,308, filed on May 10, 2023.

(51) Int. Cl. G06N 3/092; G06N 3/0475; G06N 3/091

(52) U.S. Cl. CPC G06N 3/092; G06N 3/0475; G06N 3/091

(57) ABSTRACT

A computer-implemented method includes receiving information associated with one or more machine-learned models provided by an external computing system, providing predefined code segments for obtaining human-in-the-loop reinforcement learning (HITL RL) feedback with respect to the one or more machine-learned models, identifying a selection of one or more of the predefined code segments, and generating a HITL RL framework configured to be applied to the one or more machine-learned models to obtain feedback associated with performance of the one or more machine-learned models, based on the selection of the one or more of the predefined code segments.

### PRIORITY CLAIM

This application is based on and claims priority to U.S. Provisional Application 63/501,308 having a filing date of May 10, 2023, which is incorporated by reference herein in its entirety for all purposes.

### FIELD

The disclosure relates to methods and computing systems for providing a platform for human-in-the-loop reinforcement learning. In particular, the disclosure relates to methods and computing systems for enabling a user (e.g., a developer) to deploy one or more machine-learning models (e.g., a generative model) and receive user feedback to enable human-in-the-loop reinforcement learning.

### BACKGROUND

Generally, human-in-the-loop reinforcement learning (HITL RL) is a machine-learning approach that combines the strengths of artificial intelligence (AI) and human expertise. It involves an interactive process where an AI system learns from experience while being guided or corrected by a human expert.

In HITL RL, the AI system can receive rewards or penalties based on its actions, similar to traditional reinforcement learning. However, the key difference is that a human (e.g., a human expert) provides feedback to the system, helping it learn faster and more accurately. This feedback can take many forms, such as correcting the AI's actions, providing additional information about the task or environment, or adjusting the reward function.

HITL RL may be useful in applications where the consequences of incorrect actions can be significant or costly, such as autonomous driving, medical diagnosis, and financial trading. By incorporating human expertise into the learning process, HITL RL can improve the accuracy and safety of AI systems, while reducing the time and resources required for training.

### SUMMARY

Aspects and advantages of embodiments of the disclosure will be set forth in part in the following description, or can be learned from the description, or can be learned through practice of the embodiments.

One example aspect of the disclosure is directed to a computer-implemented method for providing a HITL RL framework to obtain feedback associated with one or more machine-learned models. The method includes receiving information associated with one or more machine-learned models provided by an external computing system, providing predefined code segments for obtaining human-in-the-loop reinforcement learning (HITL RL) feedback with respect to the one or more machine-learned models, identifying a selection of one or more of the predefined code segments, and generating a HITL RL framework configured to be applied to the one or more machine-learned models to obtain feedback associated with performance of the one or more machine-learned models, based on the selection of the one or more of the predefined code segments.

In some implementations, the method includes receiving, by the computing system, the one or more machine-learned models; and updating, by the computing system, the one or more machine-learned models based on the feedback obtained via the HITL RL framework.

In some implementations, the method includes providing one or more application programming interfaces (APIs) and/or libraries to provide the predefined code segments for obtaining the HITL RL feedback.

In some implementations, the one or more machine-learned models include one or more generative machine-learned models.

In some implementations, the HITL RL framework comprises one or more user interfaces configured to provide a plurality of feedback options or feedback mechanisms.

In some implementations, the plurality of feedback options or feedback mechanisms include at least one of binary feedback, one or more rating scales, natural language feedback, interactive feedback, or A/B testing feedback.

In some implementations, providing, by the computing system, the predefined code segments for obtaining the HITL RL feedback with respect to the one or more machine-learned models comprises: providing a first set of predefined code segments which are customized for a first machine-learned model among the one or more machine-learned models, and providing a second set of predefined code segments, different from the first set of predefined code segments, which are customized for a second machine-learned model among the one or more machine-learned models.

In some implementations, the method includes implementing, by the computing system, the one or more machine-learned models; obtaining, by the computing system, feedback associated with the performance of the one or more machine-learned models from a plurality of users via the HITL RL framework; and refining the one or more machine-learned models based on the feedback obtained from the plurality of users.

In some implementations, the one or more machine-learned models include a plurality of machine-learned models, and the method comprises: implementing a first machine-learned model among the plurality of machine-learned models in parallel with a second machine-learned model among the plurality of machine-learned models; obtaining, by the computing system, first feedback associated with the performance of the first machine-learned model from a first plurality of users via the HITL RL framework; obtaining, by the computing system, second feedback associated with the performance of the second machine-learned model from a second plurality of users via the HITL RL framework; and refining at least one of the first machine-learned model or the second machine-learned model based on the first feedback and the second feedback.

In some implementations, identifying, by the computing system, the selection of the one or more of the predefined code segments comprises receiving, from the external computing device, one or more inputs selecting the one or more of the predefined code segments.

In some implementations, identifying, by the computing system, the selection of the one or more of the predefined code segments comprises the computing system automatically selecting the one or more of the predefined code segments

In some implementations, automatically selecting the one or more of the predefined code segments is based on at least one of a type of the one or more machine-learned models or a content of an input to the one or more machine-learned models.

In some implementations, the method further includes implementing, by the computing system, the one or more machine-learned models; obtaining, by the computing system, an input to the one or more machine-learned models; and filtering the input to the one or more machine-learned models based on a content of the input to generate a filtered input to be processed by the one or more machine-learned models, wherein filtering comprises ignoring or blocking one or more portions of the input from being processed by the one or more machine-learned models.

In some implementations, the method includes implementing, by the computing system, the one or more machine-learned models; obtaining, by the computing system, feedback associated with the performance of the one or more machine-learned models from a plurality of users via the HITL RL framework; and sharing the feedback obtained from the plurality of users with at least one other external computing system for refining at least one machine-learned model provided by the at least one other external computing system.

Another example aspect of the disclosure is directed to a computing system for providing a HITL RL framework to obtain feedback associated with one or more machine-learned models. The computing system includes one or more processors; and one or more non-transitory computer-readable media that store instructions that, when executed by the one or more processors, cause the computing system to perform operations, the operations comprising: receiving information associated with one or more machine-learned models provided by an external computing system; providing predefined code segments for obtaining human-in-the-loop reinforcement learning (HITL RL) feedback with respect to the one or more machine-learned models; identifying a selection of one or more of the predefined code segments; and generating a HITL RL framework configured to be applied to the one or more machine-learned models to obtain feedback associated with performance of the one or more machine-learned models, based on the selection of the one or more of the predefined code segments.

In some implementations, the operations further comprise receiving the one or more machine-learned models; and updating the one or more machine-learned models based on the feedback obtained via the HITL RL framework.

In some implementations, the operations further comprise providing one or more application programming interfaces (APIs) and/or libraries to provide the predefined code segments for obtaining the HITL RL feedback.

In some implementations, the one or more machine-learned models include one or more generative machine-learned models, the HITL RL framework comprises one or more user interfaces configured to provide a plurality of feedback options or feedback mechanisms, and the plurality of feedback options or feedback mechanisms include at least one of binary feedback, one or more rating scales, natural language feedback, interactive feedback, or A/B testing feedback.

In some implementations, identifying the selection of the one or more of the predefined code segments comprises: receiving, from the external computing device, one or more inputs selecting the one or more of the predefined code segments, or the computing system automatically selecting the one or more of the predefined code segments.

Another example aspect of the disclosure is directed to a computer-readable medium (e.g., a non-transitory computer-readable medium) for providing a HITL RL framework to obtain feedback associated with one or more machine-learned models. The non-transitory computer-readable medium stores instructions that are executable by one or more processors of a computing system, the instructions causing the one or more processors to perform operations, the operations comprising: receiving information associated with one or more machine-learned models provided by an external computing system; providing predefined code segments for obtaining human-in-the-loop reinforcement learning (HITL RL) feedback with respect to the one or more machine-learned models; identifying a selection of one or more of the predefined code segments; and generating a HITL RL framework configured to be applied to the one or more machine-learned models to obtain feedback associated with performance of the one or more machine-learned models, based on the selection of the one or more of the predefined code segments.

In some implementations the computer-readable medium stores instructions which may include instructions to cause the one or more processors to perform one or more operations of any of the methods described herein (e.g., operations of the computing system). The computer-readable medium may store additional instructions to execute other aspects of the computing system and corresponding methods of operation, as described herein.

These and other features, aspects, and advantages of various embodiments of the disclosure will become better understood with reference to the following description and appended claims. The accompanying drawings, which are incorporated in and constitute a part of this specification, illustrate example embodiments of the disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended drawings, in which:

FIG. 1 depicts a block diagram of an example system for providing a HITL RL framework to obtain feedback associated with one or more machine-learned models, according to example embodiments of the disclosure.

FIG. 2A depicts a block diagram of an example computing system that performs various tasks using a machine-learned model, according to example embodiments of the disclosure.

FIG. 2B depicts a block diagram of an example computing device that performs various tasks using a machine-learned model, according to example embodiments of the disclosure.

FIG. 2C depicts a block diagram of an example computing device that performs various tasks using a machine-learned model, according to example embodiments of the disclosure.

FIG. 3 depicts a flow chart diagram of an example method for providing a HITL RL framework to obtain feedback associated with one or more machine-learned models, according to example embodiments of the disclosure.

FIG. 4 depicts a flow chart diagram of an example method for improving a machine-learned model, according to example embodiments of the disclosure.

FIGS. 5-6 depict example aspects of a generative machine-learned applications, according to example embodiments of the disclosure.

FIGS. 7A and 7B depict example aspects of a generative machine-learned application, according to example embodiments of the disclosure.

FIGS. 8 and 9A-9C depict example aspects of a generative machine-learned application, according to example embodiments of the disclosure.

Reference numerals that are repeated across plural drawings are intended to identify the same features in various implementations.

### DETAILED DESCRIPTION

### Overview

Reference now will be made to embodiments of the disclosure, one or more examples of which are illustrated in the drawings, wherein like reference characters across drawings are intended to denote like features in various implementations. Each example is provided by way of explanation of the disclosure and is not intended to limit the disclosure.

According to examples of the disclosure, above, a computer platform for human-in-the-loop reinforcement learning includes predefined code segments of computer-executable code to enable a user (e.g., a developer) to quickly deploy a machine-learned model and receive user feedback regarding performance of the machine-learned model to enable human-in-the-loop reinforcement learning. For example, the machine-learned model may include a generative model. The predefined code segments of computer-executable code enable the user to select one or more of a plurality of available feedback options or mechanisms which may be used to modify or improve the performance of the machine-learned model.

Predefined code segments may include blocks of code that have been prewritten and are made available for a user to implement in an applications. These code segments can provide or add functionality to an application without having to write the code from scratch. Predefined code segments can take many forms, including functions, classes, and libraries. For example, a library might provide a set of predefined functions that perform common operations, such as string manipulation, file I/O, or network communication. A user can then use these functions in an application by including the library in the code and calling the functions as needed.

Predefined code segments can be provided by users or organizations that provide APIs or libraries. Example technical benefits of using predefined code segments include saving time and reducing the likelihood of errors, as the code has already been tested and proven to work correctly. In addition, predefined code segments can be customized and extended to meet the specific needs of an application. For example, users can modify the code to add new features, optimize performance, or address any issues that may arise.

In some implementations, an external computing system can provide one or more machine-learned models (or information associated with the one or more machine-learned models) to another computing system (e.g., a computing platform). A user associated with the external computing system can utilize predefined code segments provided by the computing system to obtain human-in-the-loop reinforcement learning (HITL RL) feedback with respect to the one or more machine-learned models. In some implementations, the user can manually select particular predefined code segments to customize how a user is to provide feedback for a particular machine-learned model. In some implementations, the computing system (e.g., computing platform) can automatically select the predefined code segments. A HITL RL framework can be generated by the computing system based on the selection of the one or more of the predefined code segments so that feedback associated with performance of the one or more machine-learned models can be obtained.

The computing system may be configured to receive feedback via one or more feedback mechanisms via the HITL RL framework. Example feedback mechanisms may include one or more of binary feedback, rating scales, natural language feedback, interactive feedback, A/B testing, and the like.

Binary feedback mechanisms may involve asking users to provide a binary yes/no answer to a question. For example, a user might be queried by the computing system whether a prediction made by the machine-learned model is correct or not, or whether an image or sound generated by a generative machine-learned model is accurate or generated in a manner satisfactory to the user's expectations. This type of feedback can be useful for quickly validating the accuracy of the model's predictions or of the quality of the generated content.

Rating scale feedback mechanisms may involve asking users to rate the accuracy or confidence of the model's predictions on a scale, or to rate the quality of generated content (e.g., an image or sound) generated by a generative machine-learned model. For example, a user might be queried by the computing system to rate the likelihood of a prediction being correct on a scale from 1 to 5, or to rate the quality of generated content on a scale of 1 to 5. This type of feedback can provide more granular information about the accuracy of the model's predictions or quality of generated content.

Natural language feedback mechanisms may involve allowing users to provide free-form feedback in a natural language format. For example, a user might be queried by the computing system to provide a comment or suggestion about how the machine-learned model can be improved. This type of feedback can provide more detailed and nuanced information about the user's perception of the model's performance.

Interactive feedback mechanisms may involve allowing users to interact with the machine-learned system directly. For example, in a game-like environment, a user might be enabled by the computing system to control the actions of an AI player and provide feedback on the outcomes of those actions. This type of feedback can be useful for training machine-learned models in complex and dynamic environments.

A/B testing feedback mechanisms may involve testing two different versions of a machine-learned model with different users and comparing the results. For example, one group of users might interact with a machine-learned model that has been trained using a certain reinforcement learning algorithm, while another group might interact with a second machine-learned model trained using a different algorithm. This type of feedback can be used by the computing system to compare the performance of different machine-learned models and algorithms.

The computing system may be configured to implement any one or more of the above feedback mechanisms in a modular manner such that one or more feedback mechanisms can be selected manually or automatically and implemented with the one or more machine-learned models so that feedback can be obtained regarding the performance of the one or more machine-learned models.

Implementation or selection of predefined code segments for obtaining human-in-the-loop reinforcement learning (HITL RL) feedback can be carried out by the computing system via numerous methods. For example, the computing system may be configured to generate a user interface for building code using predefined code segments for deploying a machine-learned model and receiving user feedback. The user interface may be configured to provide a modular and flexible approach for a user to customize and configure a reinforcement learning system for implementation together with one or more machine-learned models.

For example, the computing system may be configured to provide a user interface which includes a drag-and-drop interface. The user interface could allow a user to drag-and-drop predefined code segments for different components of the HITL RL framework (reinforcement learning system), such as model deployment, user feedback collection, and reinforcement learning configuration. This could simplify the process of building and configuring the feedback system.

For example, the computing system may be configured to enable a user to customize features of the HITL RL framework. The user interface may be configured to provide customization options for each predefined code segment, such as parameter tuning, input/output specifications, and interface design. This could allow users to tailor the HITL RL framework to their specific needs and preferences.

For example, the computing system may be configured to provide a user interface which provides pre-built templates for common feedback reinforcement learning applications, such as game playing, natural language processing, or image recognition. These templates could include predefined code segments and default configurations for the different components of the feedback system.

For example, the user interface may be configured to provide a real-time preview of the HITL RL framework as it is being built, allowing users to see how different code segments and configurations interact with each other. This could help users identify potential issues and adjust their configurations accordingly. For example, the user interface may be configured to provide debugging tools to help users troubleshoot errors and optimize their code. For example, the user interface could highlight syntax errors, provide code suggestions, and display error logs. For example, the user interface may be configured to provide collaboration features which enable collaboration between users (e.g., between developers and other stakeholders, such as data scientists, designers, or product managers). For example, the user interface could allow multiple users to work on the same codebase simultaneously, share comments and feedback, and track changes and versions.

For example, the HITL RL framework may be implemented via an application programming interface to allow a user to provide a machine-learned model (or information about the machine-learned model) to a computing system (computing platform) and obtain feedback from other users about the machine-learned model. For example, the computing system may be configured to define or determine API endpoints for uploading the machine-learned model (or information about the machine-learned model) to the computing system and for retrieving feedback from users about the performance of the machine-learned model.

For example, the computing system may be configured to define or determine API input/output formats for the input data for the machine-learned model and the format for the output feedback from users about the performance of the machine-learned model. For example, the computing system may be configured to implement an endpoint that allows users to upload their machine-learned model to the platform. The API may be configured to validate the format and the structure of the input data to ensure that it can be processed by the computing system.

The computing system may be configured to store the machine-learned model and the feedback data in a database or other storage mechanism. The computing system may be configured to associate the feedback with the corresponding machine-learned model.

The computing system may be configured to provide access to the feedback data, for example, via an endpoint or mechanism, for a specific machine-learned model. The API may be configured to ensure that only authorized users can access the feedback data. The computing system may be configured to aggregate and analyze the feedback data to provide insights and suggestions for improving performance of the machine-learned model. The computing system and/or external computing system may be configured to implement machine learning algorithms to learn from the feedback and make recommendations for improvements. The computing system may be configured to provide real-time monitoring and analysis of the HITL RL framework, such as the number of interactions with users and the accuracy of the model's performance (e.g., predictions, accuracy of generated content, etc.). The provided feedback can be used by the computing system and users of the external computing system to improve the accuracy and effectiveness of machine-learned models, while reducing the time and resources required for training.

The disclosure provides numerous technical effects and benefits. For example, a platform (computing system) for deploying machine-learned models using predefined code segments in a human-in-the-loop reinforcement learning framework provides several technical benefits that enhance the efficiency and effectiveness of model deployment and optimization. The platform streamlines the process of deploying machine-learned models by providing predefined code segments that can be easily integrated into the codebase associated with the machine-learned model. This simplifies the task of refining or improving a machine-learned model by reducing the need for time-consuming and complex coding, thereby saving significant development time and costs. Second, the platform enables the integration of user feedback into the machine-learned model training process. By providing various feedback mechanisms, such as binary feedback, rating scales, natural language feedback, interactive feedback, etc., the platform ensures that the machine-learned model's performance is continually monitored and improved in a user-centered manner.

Another example technical benefit includes the platform providing users with a flexible and modular approach to building and configuring their machine-learned model systems. Users (e.g., developers) can customize and configure the machine-learned model by modifying and/or implementing the predefined code segments and parameters according to the requirements of the machine-learned model. This approach enables the development of highly optimized and specialized machine-learned models that are tailored to specific use cases and applications.

As another example, the disclosed platform can offer real-time feedback and debugging tools that enable users to quickly identify and fix issues in the codebase associated with the machine-learned model. This ensures that the machine-learned model is functioning optimally and delivering accurate and reliable results. Finally, the platform enables collaboration and knowledge-sharing among users (e.g., developers and other stakeholders, such as data scientists and product managers). The platform facilitates the sharing of ideas, code, and feedback, thereby enabling the development of more efficient and effective machine-learned models.

In summary, the platform for deploying machine learning models using pre-defined code segments in a human-in-the-loop reinforcement learning framework offers significant technical benefits, including streamlined model deployment, continuous user feedback integration, flexibility and customization, real-time debugging, and collaborative development. These benefits enhance the efficiency, effectiveness, and adaptability of machine-learned models, enabling the development of highly optimized and specialized machine-learned models that deliver accurate and reliable results.

With reference now to the drawings, example embodiments of the disclosure will be discussed in further detail.

### Example Devices and Systems

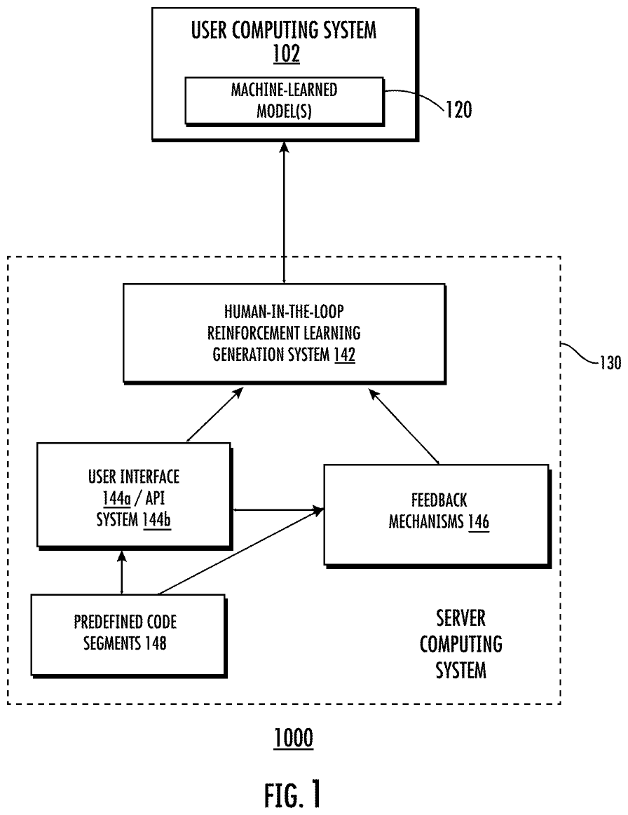

FIG. 1 illustrates an example system for providing a HITL RL framework to obtain feedback associated with one or more machine-learned models, according to example embodiments of the disclosure. In FIG. 1, the system 1000 includes a user computing system 102 which stores one or more machine-learned models 120. For example, the one or more machine-learned models 120 may include one or more generative machine-learned models.

In FIG. 1, the system 1000 includes a server computing system 130 which may include or correspond to a computing platform for providing a HITL RL framework to obtain feedback associated with one or more machine-learned models. For example, the server computing system 130 may include a HITL RL generation system 142, a user interface 144a/API system 144b, feedback mechanisms 146, and predefined code segments 148, discussed in more detail herein.

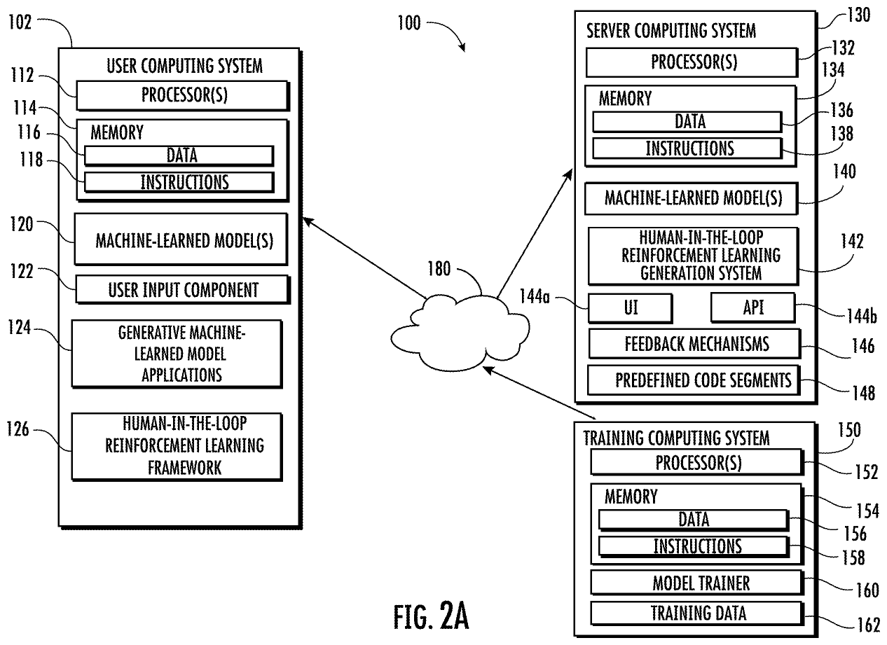

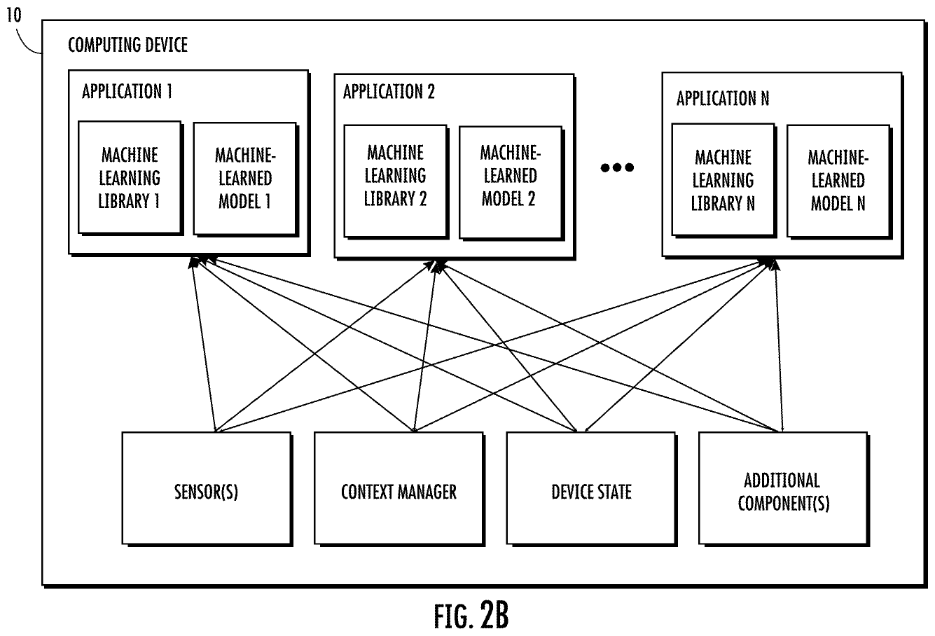

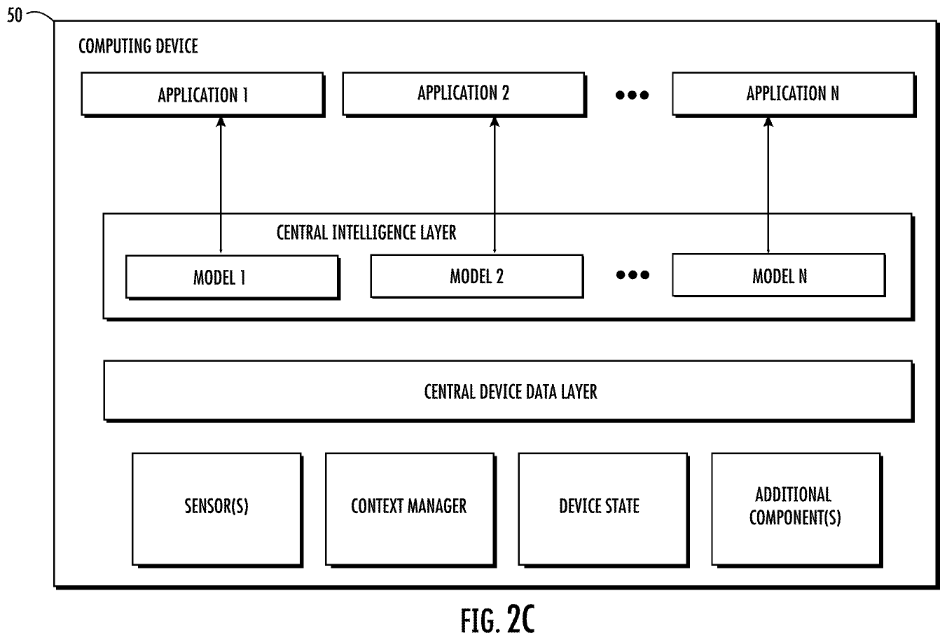

Referring to FIG. 1, a user (e.g., a developer) of the user computing system 102 may provide one or more machine-learned models 120 (or information associated with the one or more machine-learned models) to the server computing system 130 in order to implement a HITL RL system in connection with the one or more machine-learned models 120 to improve or further train the one or more machine-learned models 120. To relieve the user of having to create a HITL RL system, the server computing system 130 may be configured with the HITL RL generation system 142 to generate a HITL RL framework 126 (see FIG. 2A) that can be used to collect feedback from users of the one or more machine-learned models. For example, the HITL RL generation system 142 may be configured to provide a user interface 144a and/or API system 144b that can be implemented to select one or more feedback mechanisms 146, to configure or design user interface screens by which feedback can be provided, and to make other customizations for providing feedback, monitoring feedback, responding to feedback, and updating a machine-learned model in response to receiving the feedback.

Feedback mechanisms 146 may include one or more of binary feedback systems, rating scales feedback systems, natural language feedback systems, interactive feedback systems, A/B testing feedback systems, and the like, which have already been described in detail herein.

Predefined code segments 148 may include computer-executable code which enable a user (e.g., a developer) to quickly deploy a machine-learned model and receive user feedback regarding performance of the machine-learned model to enable human-in-the-loop reinforcement learning. The predefined code segments 148 of computer-executable code enable the user to select one or more of a plurality of available feedback options or mechanisms which may be used to modify or improve the performance of the machine-learned model. Predefined code segments 148 may include blocks of code that have been prewritten and are made available for a user to implement in an applications. These predefined code segments 148 can provide or add functionality to an application without having to write the code from scratch. Predefined code segments 148 can take many forms, including functions, classes, and libraries. For example, a library might provide a set of predefined functions that perform common operations, such as string manipulation, file I/O, or network communication. The user of user computing system 102 can select predefined code segments 148 for implementing the code segments in a machine-learned application by including the library in the code and calling the functions as needed. For example, the server computing system 130 can provide a first set of predefined code segments which are customized for a first machine-learned model among the one or more machine-learned models and a second set of predefined code segments, different from the first set of predefined code segments, which are customized for a second machine-learned model among the one or more machine-learned models. That is, the server computing system 130 can provide customized predefined code segments for respective machine-learned models.

While FIG. 1 depicts user computing system 102 as an example computing system which communicates with server computing system 130 for providing a HITL RL framework 126 to obtain feedback associated with one or more machine-learned models 120, user computing system 102 may alternatively correspond to training computing system 150 in some implementations. In addition, in some implementations the HITL RL framework 126 may be included in the server computing system 130 instead of, or in addition to, being provided to the user computing system 102. For example, a user of user computing system 102 may access a service, application, portal, etc. provided by server computing system 130 to generate and enable a HITL RL framework which can augment or be provided to one or more machine-learned models that the user wishes to obtain feedback regarding (e.g., for purposes of troubleshooting, improving performance of the machine-learned model, etc.).

FIG. 2A depicts a block diagram of an example computing system 100 that performs various tasks using a machine-learned model (e.g., a generative machine-learned model) according to example embodiments of the disclosure. The computing system 100 includes a user computing system 102, a server computing system 130, and a training computing system 150 that are communicatively coupled over a network 180.

The user computing system 102 can be any type of computing device, such as, for example, a personal computing device (e.g., laptop or desktop), a mobile computing device (e.g., smartphone or tablet), a gaming console or controller, a server computing device, or any other type of computing device.

The user computing system 102 includes one or more processors 112 and a memory 114. The one or more processors 112 can be any suitable processing device (e.g., a processor core, a microprocessor, an ASIC, an FPGA, a controller, a microcontroller, etc.) and can be one processor or a plurality of processors that are operatively connected. The memory 114 can include one or more non-transitory computer-readable storage media, such as RAM, ROM, EEPROM, EPROM, flash memory devices, magnetic disks, etc., and combinations thereof. The memory 114 can store data 116 and instructions 118 which are executed by the processor 112 to cause the user computing system 102 to perform operations.

In some implementations, the user computing system 102 can store or include one or more machine-learned models 120 (e.g., one or more generative machine-learned models). For example, the machine-learned models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models). For example, the one or more generative machine-learned models may include machine learning algorithms that can generate new data similar to data the machine-learned model was trained on. An example generative machine-learned model includes a generative adversarial network (GAN) which is a type of deep learning model that includes two neural networks: a generator and a discriminator. The generator is configured to create new data that is similar to the training data, while the discriminator tries to differentiate between the generated data and the real data. Together, the generator and discriminator work together to improve the quality of the generated data. Example machine-learned models 120 are discussed with reference to the drawings herein.

In some implementations, the one or more machine-learned models 120 can be received from the server computing system 130 over network 180, stored in the memory 114, and then used or otherwise implemented by the one or more processors 112. In some implementations, the user computing system 102 can implement multiple parallel instances of a single machine-learned model 120 (e.g., to perform parallel tasks across multiple instances of the machine-learned model 120).

More particularly, the machine-learned models disclosed herein may be trained, modified, or otherwise updated based on feedback received from users of the machine-learned models, where the server computing system 130 is configured to provide mechanisms for obtaining the feedback in a modular fashion, as described in more detail herein.

Additionally or alternatively, one or more machine-learned models 140 can be included in or otherwise stored and implemented by the server computing system 130 that communicates with the user computing system 102 according to a client-server relationship. For example, the machine-learned models 140 can be implemented by the server computing system 130 as a portion of a web service (e.g., a recommendation service, a search service, an image analysis service, and the like). Thus, one or more machine-learned models 120 can be stored and implemented at the user computing system 102 and/or one or more machine-learned models 140 can be stored and implemented at the server computing system 130.

The user computing system 102 can also include one or more user input components 122 that receives a user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other devices by which a user can provide user input (e.g., a camera which captures an image).

The user computing system 102 can also include one or more generative machine-learned model applications 124. For example, the one or more generative machine-learned model applications 124 may include any application which is configured to generate content (e.g., text, images, videos, sound, music, combinations thereof, etc.) via a generative machine-learned model. The one or more generative machine-learned model applications 124, when executed, may receive an input or prompt from a user to generate content. In some implementations, the user can provide feedback regarding an output of the generative machine-learned model, as described herein.

According to examples of the disclosure, the user computing system 102 can also include a HITL RL framework 126 which is configured to receive the feedback from the user. The HITL RL framework 126 may be implemented together with the one or more generative machine-learned model applications 124 and may include one or more user interfaces that have been selected or generated via HITL RL generation system 142. The one or more user interfaces may be configured to provide a plurality of feedback options or feedback mechanisms. The plurality of feedback options or feedback mechanisms may include binary feedback, one or more rating scales, natural language feedback, interactive feedback, A/B testing feedback, and the like.

The server computing system 130 includes one or more processors 132 and a memory 134. The one or more processors 132 can be any suitable processing device (e.g., a processor core, a microprocessor, an ASIC, an FPGA, a controller, a microcontroller, etc.) and can be one processor or a plurality of processors that are operatively connected. The memory 134 can include one or more non-transitory computer-readable storage media, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned models 140. For example, the machine-learned models 140 can be or can otherwise include various machine-learned models (e.g., one or more generative machine-learned models). Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models). An example generative machine-learned model includes a generative adversarial network (GAN) which is a type of deep learning model that includes two neural networks: a generator and a discriminator. The generator is configured to create new data that is similar to the training data, while the discriminator tries to differentiate between the generated data and the real data. Together, the generator and discriminator work together to improve the quality of the generated data. Example machine-learned models 120 are discussed with reference to the drawings herein. Example machine-learned models 140 are discussed herein with reference to the drawings.

The user computing system 102 and/or the server computing system 130 can train the machine-learned models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, an FPGA, a controller, a microcontroller, etc.) and can be one processor or a plurality of processors that are operatively connected. The memory 154 can include one or more non-transitory computer-readable storage media, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing system 102 and/or the server computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the machine-learned models 120 and/or 140 based on a set of training data 162. The training data 162 can include, for example, various datasets which may be stored remotely or at the training computing system 150.

In some implementations, if the user has provided consent, the training examples can be provided by the user computing system 102. Thus, in such implementations, the machine-learned model 120 provided to the user computing system 102 can be trained by the training computing system 150 on user-specific data received from the user computing system 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM, hard disk, or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The machine-learned models described in this specification may be used in a variety of tasks, applications, and/or use cases.

In some implementations, the input to the machine-learned model(s) of the disclosure is a query or prompt. The query or prompt may include a request to generate content (e.g., text, images, videos, sound, music, combinations thereof, and the like.

Example generative machine-learned models may include a generative machine-learned model which receives an input (e.g., a text input, voice input, image input, etc.) where the input is a request for the machine-learned model to generate a sound (e.g., music) according to one or more parameters provided via the input, and the machine-learned model generates, as an output, the sound (e.g., music), based on the one or more parameters of the input. For example, the input may be a request for the machine-learned model to generate music having a particular tone or mood, to generate music similar to a particular composer or musician, etc.

Example generative machine-learned models may include a generative machine-learned model which receives an input (e.g., a text input, voice input, image input, etc.) where the input is a request for the machine-learned model to generate an image or video according to one or more parameters provided via the input, and the machine-learned model generates, as an output, the image or video, based on the one or more parameters of the input. For example, the input may be a request for the machine-learned model to generate an image of an imaginary animal, of a human wearing clothing of a particular style or fashion, to generate a picture which has a style that is similar to a particular artist, etc.

Example generative machine-learned models may include a generative machine-learned model which receives an input (e.g., a text input, voice input, image input, etc.) where the input is a request for the machine-learned model to generate text according to one or more parameters provided via the input, and the machine-learned model generates, as an output, the text, based on the one or more parameters of the input. For example, the input may be a request for the machine-learned model to generate a story which is written in a particular style or format, to generate an essay on a subject, to generate a list with a plurality of items to complete a task, etc.

Example generative machine-learned models may include a generative machine-learned model which receives an input (e.g., a text input, voice input, image input, etc.) where the input is a request for the machine-learned model to generate a combination of two or more types of content (e.g., an image, a video, sound, music, text, etc.) according to one or more parameters provided via the input, and the machine-learned model generates, as an output, the two or more types of content based on the one or more parameters of the input.

For example, the input may be a request for the machine-learned model to generate a story which is written in a particular style or format with background music playing while the story is read aloud. For example, the input may be a request for the machine-learned model to generate music based on a prompt provided by a user, where the generative machine-learned model is configured to generate images in the form of sound waves which correspond to the music which is also generated by the machine-learned model. For example, the input may be a combination of inputs (e.g., a request for the machine-learned model to generate music based on artwork according to a combination of inputs including an image by an artist and a text description of the artwork.

FIG. 2A illustrates one example computing system that can be used to implement the disclosure. Other computing systems can be used as well. For example, in some implementations, the user computing system 102 can include the model trainer 160 and the training data 162. In such implementations, the machine-learned models 120 can be both trained and used locally at the user computing system 102. In some of such implementations, the user computing system 102 can implement the model trainer 160 to personalize the machine-learned models 120 based on user-specific data.

FIG. 2B depicts a block diagram of an example computing device 10 that performs according to example embodiments of the disclosure. The computing device 10 can be a user computing device or a server computing device.

The computing device 10 includes a number of applications (e.g., applications 1through N). Each application contains its own machine learning library and machine-learned model(s). For example, each application can include a machine-learned model. Example applications include a text messaging application, an email application, a dictation application, a virtual keyboard application, a browser application, a text generation application, an image generation application, a video generation application, a sound generation application, a music generation application, etc.

As illustrated in FIG. 2B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 2C depicts a block diagram of an example computing device 50 that performs according to example embodiments of the disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 2C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 2C, the central device data layer can communicate with a number of other components of the computing device, such as, for example, one or more sensors, a context manager, a device state component, and/or additional components. In some implementations, the central device data layer can communicate with each device component using an API (e.g., a private API).

### Example Methods

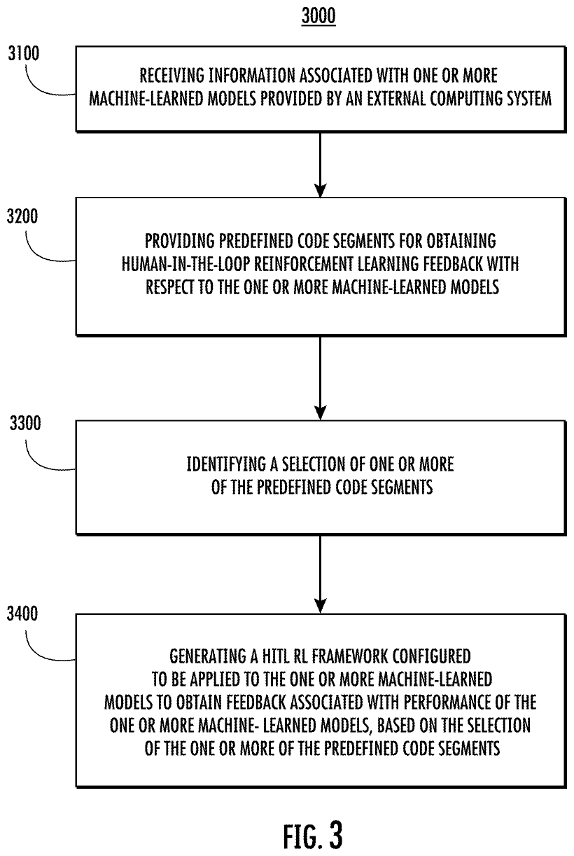

FIG. 3 depicts a flow chart diagram of an example method for providing a HITL RL framework to obtain feedback associated with one or more machine-learned models, according to example embodiments of the disclosure. Although FIG. 3 depicts operations performed in a particular order for purposes of illustration and discussion, the methods of the disclosure are not limited to the particularly illustrated order or arrangement. The various operations of the method 3000 can be omitted, rearranged, combined, and/or adapted in various ways without deviating from the scope of the disclosure.

At 3100, a computing system (e.g., a computing platform or server computing system 130) receives information associated with one or more machine-learned models provided by an external computing system (e.g., user computing system 102. For example, the information associated with one or more machine-learned models can include information about a type of the machine-learned model, information about an input and/or output associated with the machine-learned model, the machine-learned model itself, and the like.

At 3200, the computing system provides predefined code segments for obtaining human-in-the-loop reinforcement learning (HITL RL) feedback with respect to the one or more machine-learned models. For example, predefined code segments 148 may be provided via a user interface 144a and/or an API 144b. The predefined code segments 148 may include blocks of code that have been prewritten and are made available for a user of the external computing system to implement in connection with the machine-learned model. The predefined code segments 148 can provide or add functionality to an application without having to write the code from scratch. Predefined code segments can take many forms, including functions, classes, and libraries. For example, a library might provide a set of predefined functions that perform common operations, such as string manipulation, file I/O, or network communication. A user can then use these functions in an application by including the library in the code and calling the functions as needed. The predefined code segments 148 can be customized and extended to meet the specific needs of an application.

At 3300, the computing system identifies a selection of one or more of the predefined code segments. For example, a user associated with the external computing system can utilize the predefined code segments 148 provided by the computing system to obtain human-in-the-loop reinforcement learning (HITL RL) feedback with respect to the one or more machine-learned models. In some implementations, the user can manually select particular predefined code segments 148 to customize how a user is to provide feedback for a particular machine-learned model. In some implementations, the computing system (e.g., computing platform) can automatically select the predefined code segments 148. A HITL RL framework can be generated by the computing system based on the selection of the one or more of the predefined code segments so that feedback associated with performance of the one or more machine-learned models can be obtained.

At 3400, the computing system generates a HITL RL framework configured to be applied to the one or more machine-learned models to obtain feedback associated with performance of the one or more machine-learned models, based on the selection of the one or more of the predefined code segments.

For example, the computing system may be configured to generate a user interface which is configured to receive feedback from a user relating to performance of the machine-learned model.

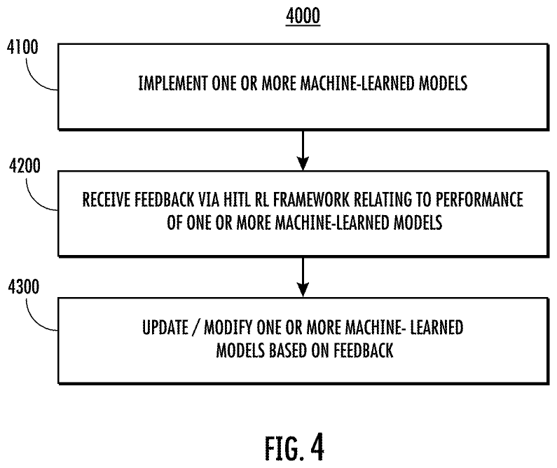

FIG. 4 depicts a flow chart diagram of an example method for improving a machine-learned model, according to example embodiments of the disclosure. Although FIG. 4 depicts operations performed in a particular order for purposes of illustration and discussion, the methods of the disclosure are not limited to the particularly illustrated order or arrangement. The various operations of the method 4000 can be omitted, rearranged, combined, and/or adapted in various ways without deviating from the scope of the disclosure.

At 4100, the computing system (e.g., user computing system 102, server computing system 130, training computing system 150) may implement one or more machine-learned models. For example, the one or more machine-learned model may be a generative machine-learned model. The one or more machine-learned models may be implemented by a user providing an input (prompt) and the one or more machine-learned models providing an output in response to the input. In some implementations, the computing system (e.g., user computing system 102, server computing system 130, training computing system 150) may be configured to filter the input to the one or more machine-learned models based on a content of the input to generate a filtered input to be processed by the one or more machine-learned models, wherein filtering including ignoring or blocking one or more portions of the input from being processed by the one or more machine-learned models. For example, certain words or phrases in the input may be offensive or profane, may have legal implications, etc., and therefore are filtered and not considered by the one or more machine-learned models.

At 4200, the computing system (e.g., user computing system 102, server computing system 130, training computing system 150) may receive feedback from one or more users via the HITL RL framework which relates to performance of the one or more machine-learned models. For example, the feedback may be in any form and may include a rating, a natural language feedback, a binary feedback, a comparison between different outputs, a comparison of different models, etc. The feedback may be received from a single user or from a plurality of users via the HITL RL framework. In some implementations, the computing system (e.g., user computing system 102, server computing system 130, training computing system 150) may be configured to share the feedback obtained from the single user or the plurality of users with at least one other external computing system for refining at least one machine-learned model (e.g., which may also be provided by the at least one other external computing system).

At 4300, the computing system (e.g., user computing system 102, server computing system 130, training computing system 150) may update or modify or refine the one or more machine-learned models based on the feedback (obtained from a single user or from a plurality of users). For example, the one or more machine-learned models may be modified by changing various parameters of the machine-learned model including values associated with various weights, tuning of certain variables of the machine-learned model, etc.

In some implementations the method of FIG. 4 may be performed in parallel with respect to different machine-learned models. For example, the computing system (e.g., user computing system 102, server computing system 130, training computing system 150) may be configured to implement a first machine-learned model among the plurality of machine-learned models in parallel with a second machine-learned model among the plurality of machine-learned models, obtain first feedback associated with the performance of the first machine-learned model from a first plurality of users via the HITL RL framework 126, obtain second feedback associated with the performance of the second machine-learned model from a second plurality of users via the HITL RL framework 126, and refine at least one of the first machine-learned model or the second machine-learned model based on the first feedback and the second feedback.

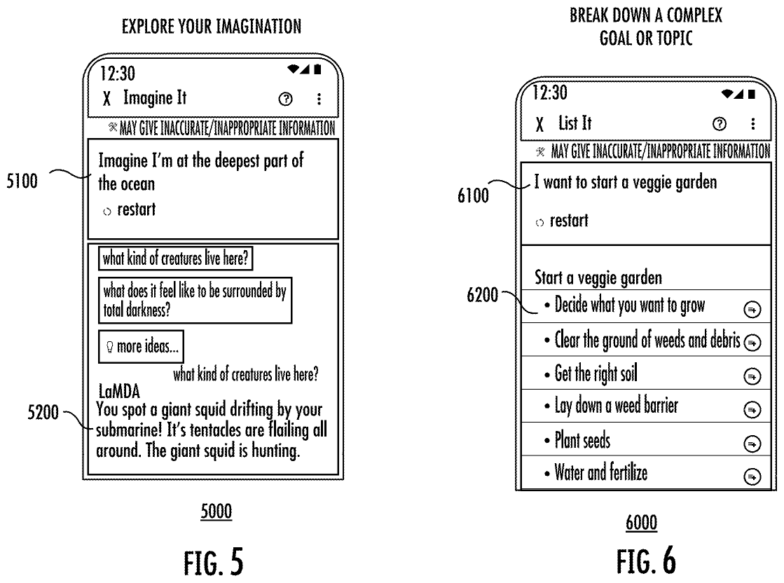

FIGS. 5-6 depict example generative machine-learned applications, according to example embodiments of the disclosure. For example, in FIG. 5, user interface 5000 depicts an interface by which a user has provided a prompt 5100 describing a scenario and an output 5200 in the form of text is provided via the generative machine-learned model which describes the scenario in an imaginative story-like fashion. For example, in FIG. 6, user interface 6000 depicts an interface by which a user has provided a prompt 6100 describing a task to be accomplished and an output 6200 in the form of text is provided via the generative machine-learned model which describes items to be accomplished in order to complete the task.

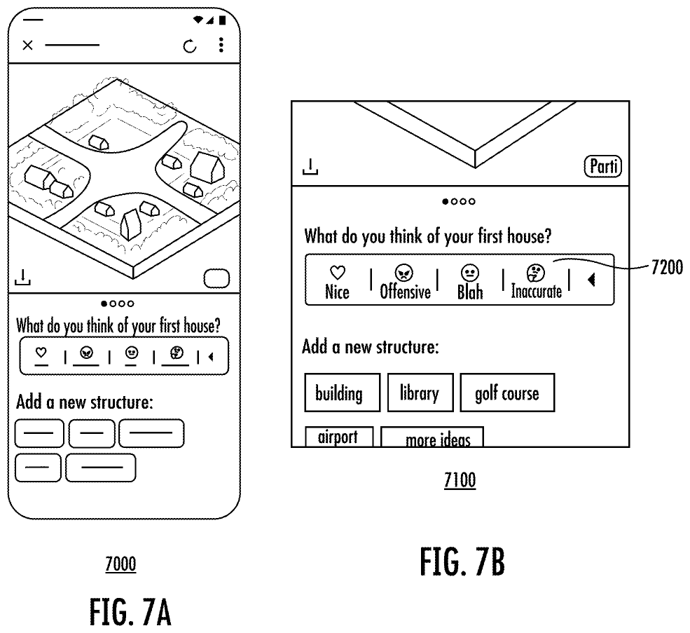

FIGS. 7A and 7B depict example aspects of a generative machine-learned application, according to example embodiments of the disclosure. For example, in FIG. 7A, user interface 7000 depicts an interface by which a user can provide an input to request that the generative machine-learned application generate various items for a city in a city building game, such as a house. For example, in FIG. 7B, user interface 7100 depicts an example rating feedback mechanism 7200 by which a user can provide feedback on the generated item (e.g., a house). The feedback may be provided to the computing system for determining whether improvements to the generative machine-learned model need to be made or determining whether the output of the generative machine-learned model is satisfactory.

In example implementations, the HITL RL generation system 142 may be configured to provide a user interface 144a and/or API 144b by which a user of user computing system 102 may select user interfaces having feedback mechanisms like that shown in FIG. 7B which are customized for the machine-learned model provided by the user computing system 102. For example, a template may be provided to simplify the creation and implementation of feedback mechanisms (e.g., a generic statement such as “What do you think of your XYZ” where the term XYX may be customized by the developer).

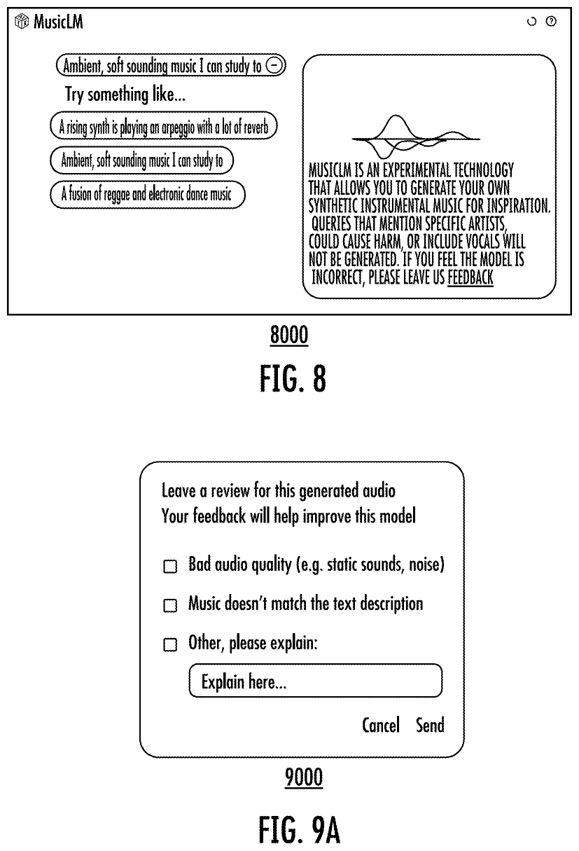

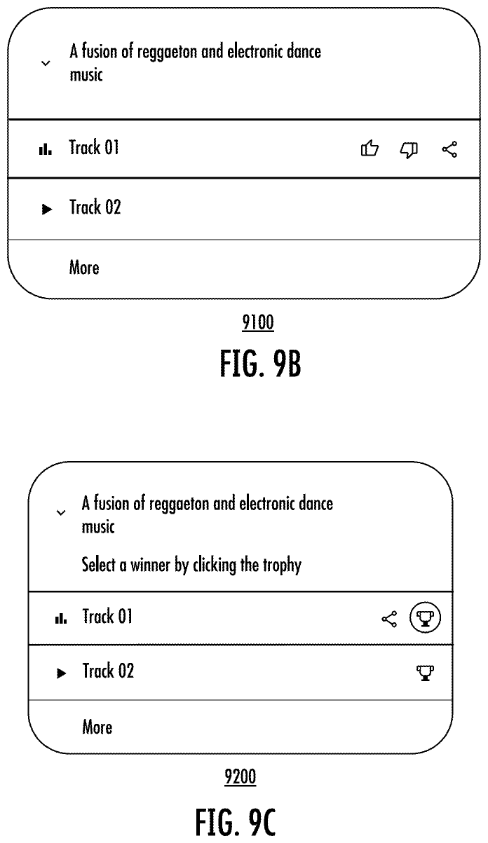

FIGS. 8 and 9A-9C depict example aspects of a generative machine-learned application, according to example embodiments of the disclosure. For example, in FIG. 8, user interface 8000 depicts an interface by which a user can provide an input to request that the generative machine-learned application generate music which soft sounding and conducive to studying. For example, in FIGS. 9A-9C, example user interfaces are depicted by which a user can provide feedback on the generated item (e.g., music). For example, FIG. 9A illustrates a user interface 9000 by which a user can select from predetermined options or provide a natural language type feedback. For example, FIG. 9A illustrates a user interface 9000 by which a user can select from predetermined options or provide a natural language type feedback. For example, FIG. 9B illustrates a user interface 9100 by which a user can provide binary feedback in the form a thumbs up or thumbs down. For example, FIG. 9C illustrates a user interface 9200 by which a user can choose between two outputs an output which better meets the user's expectations. In addition, a user can share an output with other users, and the act of sharing can also be used as part of a feedback mechanism. The feedback provided via any of user interfaces shown in FIGS. 9A-9C may be provided to the computing system for determining whether improvements to the generative machine-learned model need to be made or determining whether the output of the generative machine-learned model is satisfactory. In example implementations, the HITL RL generation system 142 may be configured to provide a user interface 144a and/or API 144b by which a user of user computing system 102 may select user interfaces having feedback mechanisms like that shown in FIGS. 9A-9C which are customized for the machine-learned model provided by the user computing system 102. For example, a template may be provided to simplify the creation and implementation of feedback mechanisms (e.g., generic icons or symbols such as the thumb icons or generic predetermined statements which can be customized by the developer as needed).

Collecting feedback from users of various machine-learned models can be useful for refining or improving a machine-learned model and improving the accuracy of an output produced by the machine-learned model and/or of improving a result which better meets the expectations of the user. According to aspects of the disclosure as described herein, a computing platform may be provided which enables a user (e.g., a developer) to implement their machine-learned model in a HITL RL environment so as to be able to collect feedback from a plurality of users and improve the performance of the machine-learned model.

Feedback may include feedback concerning a quality of the output generated by the machine-learned model, a quality of the prompts provided to obtain an input from the user to generate the output, feedback on the content of the prompts provided to generate the output, an accuracy of the output generated by the machine-learned model, etc. In the context of a generative machine-learned model which generates music, the feedback may include feedback on perceived audio quality, feedback on the initial prompts provided by the user to generate the music, feedback on the users who are using the machine-learned model to generate the music, etc. The feedback may be used to generate or modify user interfaces or user interface elements for an existing user interface that is implemented by the machine-learned model as well as to improve the machine-learned model itself.

The feedback may also be used to implement filters to prevent or avoid outputting content which is improper, inaccurate, inappropriate, etc.

The feedback may also be used to implement filters to prevent or avoid receiving inputs (or prevent or avoid processing inputs) which are improper, inaccurate, inappropriate, etc. For example, the computing platform may be configured to exclude, ignore, and/or block prompts (inputs) which are improper or inappropriate (e.g., profanity, offensive, illegal, etc.). The computing platform may be configured to utilize feedback provided by users to update or modify a block list for various prompts (inputs) based on the received feedback.

The computing platform as described herein can enable developers to quickly deploy machine-learned models and receive user feedback to enable human-in-the-loop reinforcement learning. This can improve the accuracy and effectiveness of machine-learned systems, while reducing the time and resources required for training.

### Additional Disclosure

Terms used herein are used to describe the example embodiments and are not intended to limit and/or restrict the disclosure. The singular forms “a,” “an” and “the” are intended to include the plural forms as well, unless the context clearly indicates otherwise. In this disclosure, terms such as “including”, “having”, “comprising”, and the like are used to specify features, numbers, steps, operations, elements, components, or combinations thereof, but do not preclude the presence or addition of one or more of the features, elements, steps, operations, elements, components, or combinations thereof.

It will be understood that, although the terms first, second, third, etc., may be used herein to describe various elements, the elements are not limited by these terms. Instead, these terms are used to distinguish one element from another element. For example, without departing from the scope of the disclosure, a first element may be termed as a second element, and a second element may be termed as a first element.

It will be understood that when an element is referred to as being “connected” to another element, the expression encompasses an example of a direct connection or direct coupling, as well as a connection or coupling with one or more other elements interposed therebetween.

The term “and/or” includes a combination of a plurality of related listed items or any item of the plurality of related listed items. For example, the scope of the expression or phrase “A and/or B” includes the item “A”, the item “B”, and the combination of items “A and B”.

In addition, the scope of the expression or phrase “at least one of A or B” is intended to include all of the following: (1) at least one of A, (2) at least one of B, and (3) at least one of A and at least one of B. Likewise, the scope of the expression or phrase “at least one of A, B, or C” is intended to include all of the following: (1) at least one of A, (2) at least one of B, (3) at least one of C, (4) at least one of A and at least one of B, (5) at least one of A and at least one of C, (6) at least one of B and at least one of C, and (7) at least one of A, at least one of B, and at least one of C.

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the subject matter as would be readily apparent to one of ordinary skill in the art. For instance, features illustrated or described as part of one embodiment can be used with another embodiment to yield a still further embodiment. Thus, it is intended that the disclosure cover such alterations, variations, and equivalents.

What is claimed is:

1. A computer-implemented method, comprising:
receiving, by a computing system, information associated with one or more machine-learned models provided by an external computing system;
providing, by the computing system, predefined code segments for obtaining human-in-the-loop reinforcement learning (HITL RL) feedback with respect to the one or more machine-learned models;
identifying, by the computing system, a selection of one or more of the predefined code segments; and
generating, by the computing system, a HITL RL framework configured to be applied to the one or more machine-learned models to obtain feedback associated with performance of the one or more machine-learned models, based on the selection of the one or more of the predefined code segments.

2. The computer-implemented method of claim 1, further comprising:
receiving, by the computing system, the one or more machine-learned models; and
updating, by the computing system, the one or more machine-learned models based on the feedback obtained via the HITL RL framework.

3. The computer-implemented method of claim 2, further comprising providing one or more application programming interfaces (APIs) and/or libraries to provide the predefined code segments for obtaining the HITL RL feedback.

4. The computer-implemented method of claim 3, wherein the one or more machine-learned models include one or more generative machine-learned models.

5. The computer-implemented method of claim 1, wherein the HITL RL framework comprises one or more user interfaces configured to provide a plurality of feedback options or feedback mechanisms.

6. The computer-implemented method of claim 5, wherein the plurality of feedback options or feedback mechanisms include at least one of binary feedback, one or more rating scales, natural language feedback, interactive feedback, or A/B testing feedback.

7. The computer-implemented method of claim 1, wherein providing, by the computing system, the predefined code segments for obtaining the HITL RL feedback with respect to the one or more machine-learned models comprises:
providing a first set of predefined code segments which are customized for a first machine-learned model among the one or more machine-learned models, and
providing a second set of predefined code segments, different from the first set of predefined code segments, which are customized for a second machine-learned model among the one or more machine-learned models.

8. The computer-implemented method of claim 1, further comprising:
implementing, by the computing system, the one or more machine-learned models;
obtaining, by the computing system, feedback associated with the performance of the one or more machine-learned models from a plurality of users via the HITL RL framework; and
refining the one or more machine-learned models based on the feedback obtained from the plurality of users.

9. The computer-implemented method of claim 1, wherein the one or more machine-learned models include a plurality of machine-learned models, and the method comprises:
implementing a first machine-learned model among the plurality of machine-learned models in parallel with a second machine-learned model among the plurality of machine-learned models;
obtaining, by the computing system, first feedback associated with the performance of the first machine-learned model from a first plurality of users via the HITL RL framework;
obtaining, by the computing system, second feedback associated with the performance of the second machine-learned model from a second plurality of users via the HITL RL framework; and
refining at least one of the first machine-learned model or the second machine-learned model based on the first feedback and the second feedback.

10. The computer-implemented method of claim 1, wherein identifying, by the computing system, the selection of the one or more of the predefined code segments comprises receiving, from the external computing device, one or more inputs selecting the one or more of the predefined code segments.

11. The computer-implemented method of claim 1, wherein identifying, by the computing system, the selection of the one or more of the predefined code segments comprises the computing system automatically selecting the one or more of the predefined code segments.

12. The computer-implemented method of claim 11, wherein automatically selecting the one or more of the predefined code segments is based on at least one of a type of the one or more machine-learned models or a content of an input to the one or more machine-learned models.

13. The computer-implemented method of claim 1, further comprising:
implementing, by the computing system, the one or more machine-learned models;
obtaining, by the computing system, an input to the one or more machine-learned models; and
filtering the input to the one or more machine-learned models based on a content of the input to generate a filtered input to be processed by the one or more machine-learned models, wherein filtering comprises ignoring or blocking one or more portions of the input from being processed by the one or more machine-learned models.

14. The computer-implemented method of claim 1, further comprising:
implementing, by the computing system, the one or more machine-learned models;
obtaining, by the computing system, feedback associated with the performance of the one or more machine-learned models from a plurality of users via the HITL RL framework; and
sharing the feedback obtained from the plurality of users with at least one other external computing system for refining at least one machine-learned model provided by the at least one other external computing system.

15. A computing system, comprising:
one or more processors; and
one or more non-transitory computer-readable media that store instructions that, when executed by the one or more processors, cause the computing system to perform operations, the operations comprising:
receiving information associated with one or more machine-learned models provided by an external computing system;
providing predefined code segments for obtaining human-in-the-loop reinforcement learning (HITL RL) feedback with respect to the one or more machine-learned models;
identifying a selection of one or more of the predefined code segments; and
generating a HITL RL framework configured to be applied to the one or more machine-learned models to obtain feedback associated with performance of the one or more machine-learned models, based on the selection of the one or more of the predefined code segments.

16. The computing system of claim 15, wherein the operations further comprise:
receiving the one or more machine-learned models; and
updating the one or more machine-learned models based on the feedback obtained via the HITL RL framework.

17. The computing system of claim 16, wherein the operations further comprise providing one or more application programming interfaces (APIs) and/or libraries to provide the predefined code segments for obtaining the HITL RL feedback.

18. The computing system of claim 17, wherein
the one or more machine-learned models include one or more generative machine-learned models,
the HITL RL framework comprises one or more user interfaces configured to provide a plurality of feedback options or feedback mechanisms, and
the plurality of feedback options or feedback mechanisms include at least one of binary feedback, one or more rating scales, natural language feedback, interactive feedback, or A/B testing feedback.

19. The computing system of claim 15, wherein identifying the selection of the one or more of the predefined code segments comprises:
receiving, from the external computing device, one or more inputs selecting the one or more of the predefined code segments, or
the computing system automatically selecting the one or more of the predefined code segments.

20. A non-transitory computer-readable medium which stores instructions that are executable by one or more processors of a computing system, the instructions causing the one or more processors to perform operations, the operations comprising:
receiving information associated with one or more machine-learned models provided by an external computing system;
providing predefined code segments for obtaining human-in-the-loop reinforcement learning (HITL RL) feedback with respect to the one or more machine-learned models;
identifying a selection of one or more of the predefined code segments; and
generating a HITL RL framework configured to be applied to the one or more machine-learned models to obtain feedback associated with performance of the one or more machine-learned models, based on the selection of the one or more of the predefined code segments.
